(19) United States
(12) Patent Application Publication
(10) Pub. No.: US 2013/0346153 A1
(43) Pub. Date: Dec. 26, 2013

(54) PRODUCTS OR SERVICES DEMAND ANALYTICS SYSTEMS AND RELATED METHODS AND ELECTRONIC EXCHANGES

(71) Applicant: BuyStand, LLC, Durham, NC (US)

(72) Inventors: Ted Rudner Kraus, Memphis, TN (US); Joseph P. Davy, Durham, NC (US); Glenn William Brown, JR., Durham, NC (US); Daniel Friel, Charlotte, NC (US); Philip DeSimone, Chapel Hill, NC (US)

(21) Appl. No.: 13/911,770

(22) Filed: Jun. 6, 2013

Related U.S. Application Data
(60) Provisional application No. 61/663,243, filed on Jun. 22, 2012.

(51) Int. Cl. G06Q 30/06

(52) U.S. Cl. CPC G06Q 30/0623
USPC 705/7.31; 705/26.61

(57) ABSTRACT

Products or services demand analytics systems are provided. The systems may include a processor configured to determine whether to make an offer from a buyer to purchase a product or service at a buyer-determined price available to a seller of the product or service, based on a demand analytics preference of the seller for the product or service. Moreover, the processor may be configured to adjust whether the offer is made available to the seller and/or how the offer is communicated to the seller in response to an adjustment by the seller of the demand analytics preference for the product or service. Related methods and electronic exchanges are also described.

### CLAIM OF PRIORITY

The present application claims the benefit of U.S. Provisional Patent Application Ser. No. 61/663,243, filed on Jun. 22, 2012, entitled Systems, Methods, and Electronic Exchanges for Facilitating a Buyer-Driven Transaction, the disclosure of which is incorporated herein in its entirety by reference. Additionally, the present application is related to U.S. patent application Ser. No. 13/911,671, filed on Jun. 6, 2013, entitled Methods and Electronic Exchanges for Facilitating a Buyer-Driven Transaction, the disclosure of which is incorporated herein in its entirety by reference.

### FIELD

The present disclosure relates to demand analytics systems for products or services.

### BACKGROUND

Retailers of consumer goods have traditionally reduced their prices on inventory items after demand for the inventory items declines. For example, a retailer may reduce its price on a particular inventory item from a retail price (e.g., a Manufacturer's Suggested Retail Price (MSRP)) to a sale price. Moreover, the retailer may further reduce the price on the particular inventory item from the sale price to a clearance price. Such a retailer is using a seller-driven model for determining its price because the retailer, rather than the buyer, determines the price.

Although the retailer may sell more units of the particular inventory item by reducing the price, the retailer's profit margin typically declines as the retailer reduces the price. Additionally, imprecision in calculating demand and pricing may result in the retailer's reduced price being higher or lower than what the demand from buyers would dictate. For example, if the price is too high, then the retailer may sell too few units and have excess inventory, and buyers may have to wait for a sale for the price to decrease. Alternatively, if the price is too low, then the retailer's profit margin may decrease, unnecessarily.

In contrast with the traditional seller-driven model for determining prices, one example of a buyer-driven marketplace is the Priceline.com® “Name Your Own Price®” model, which allows a buyer to submit a bid for a service such as an airline flight, in return for the buyer's flexibility with regard to certain details (e.g., time, operating airline, etc.) of the airline flight. In other words, the “Name Your Own Price®” model works if a buyer is only concerned with price and is not concerned with specific flight times, airlines, seats, etc.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Various embodiments of the present inventive concepts include methods of facilitating a buyer-driven transaction. The methods may include receiving at an electronic exchange a plurality of offers from a plurality of respective buyers to purchase a consumer good (e.g., a product or service) at a plurality of respective buyer-determined prices. The methods may also include searching seller inventory data (or seller capacity data) from at least one database to match the plurality of offers with at least one seller inventory (or seller schedule) that includes the consumer good. The methods may further include using one or more filters to optimize the plurality of offers that match a seller inventory (or seller schedule) among the at least one seller inventory (or seller schedule) for a particular seller, based on a demand analytics preference of the particular seller for the consumer good, by determining whether to make the plurality of offers available to the particular seller and/or how to communicate (e.g., display) the plurality of offers to the particular seller. The plurality of offers from the plurality of respective buyers may be a plurality of unconditional offers from the plurality of respective buyers.

According to various embodiments, optimizing the plurality of offers includes sorting the plurality of offers based on at least one of profit margin for the particular seller with respect to the consumer good (e.g., a product or service) at the plurality of buyer-determined prices and a comparison of raw prices of the plurality offers for the consumer good.

In various embodiments, the methods may include receiving at the electronic exchange an acceptance of at least one of the plurality of offers from an individual seller whose inventory (or schedule) is included among the at least one seller inventory (or schedule).

According to various embodiments, the individual seller may be the particular seller for whom the plurality of offers are optimized.

In various embodiments, the methods may include providing a suggestion to one of the plurality of buyers of a comparable consumer good (e.g., a comparable product or service) with respect to the consumer good and/or a complementary consumer good with respect to the consumer good.

According to various embodiments, providing the suggestion may include providing the suggestion in response to at least one of acceptance of an offer from the one of the plurality of buyers by an individual seller whose inventory (or schedule) is included among the at least one seller inventory (or schedule) and rejection of the offer by the individual seller.

Electronic exchanges for facilitating a buyer-driven transaction, according to various embodiments, may include an electronic order book configured to receive an offer from a buyer to purchase a consumer good (e.g., a product or service) at a buyer-determined price, and to receive an acceptance of the offer from an individual seller. The electronic exchanges may also include an inventory processor configured to search seller inventory data (or capacity data) to match the offer with at least one seller inventory (or seller schedule) that includes the consumer good. An inventory (or schedule) of the individual seller may be included among the at least one seller inventory. The electronic exchanges may further include a demand analytics processor configured to determine whether to make the offer available to a particular seller after the inventory processor matches the offer with the particular seller, based on a demand analytics preference for the consumer good. The demand analytics processor may be further configured to adjust whether the offer is made available to the particular seller and/or how the offer is communicated (e.g., displayed) to the particular seller in response to an adjustment by the particular seller of the demand analytics preference for the consumer good. The offer from the buyer may be an unconditional offer from buyer.

According to various embodiments, the demand analytics preference for the consumer good (e.g., product or service) may include a preference with respect to at least one of profit margin for the particular seller with respect to the consumer good at the buyer-determined price and a comparison of the offer with at least one other offer for the consumer good.

In various embodiments, the adjustment may be entered via a user interface of an electronic device of the particular seller.

According to various embodiments, the demand analytics processor may be further configured to determine a suggestion for the buyer of a comparable consumer good (e.g., a comparable product or service) with respect to the consumer good and/or a complementary consumer good with respect to the consumer good.

In various embodiments, the demand analytics processor may be further configured to provide the suggestion to the buyer in response to at least one of acceptance of the offer by the individual seller, rejection of the offer by the particular seller, and failure of the buyer to make the offer within a threshold time period.

According to various embodiments, the individual seller may include the particular seller having the demand analytics preference for the consumer good (e.g., product or service).

Consumer goods (e.g., products or services) demand analytics systems according to various embodiments may include a processor configured to determine whether to make an offer from a buyer to purchase a consumer good (e.g., a product or service) at a buyer-determined price available to a seller of the consumer good, based on a demand analytics preference of the seller for the consumer good. The processor may be further configured to adjust whether the offer is made available to the seller and/or how the offer is communicated (e.g., displayed) to the seller in response to an adjustment by the seller of the demand analytics preference for the consumer good. The offer from the buyer may be an unconditional offer from buyer.

According to various embodiments, the demand analytics preference for the consumer good (e.g., product or service) may include a preference with respect to at least one of profit margin for the seller with respect to the consumer good at the buyer-determined price and a comparison of the offer with at least one other offer for the consumer good.

In various embodiments, the comparison of the offer with at least one other offer for the consumer good may include ranking the offer and the at least one other offer.

According to various embodiments, the processor may be further configured to determine a suggestion for the buyer of a comparable consumer good (e.g., a comparable product or service) with respect to the consumer good and/or a complementary consumer good with respect to the consumer good.

In various embodiments, the processor may be further configured to determine real-time demand information for the consumer good (e.g., product or service) and to provide the real-time demand information to the seller.

In various embodiments, the real-time demand information may include a plurality of offers from a plurality of buyers for the consumer good (e.g., product or service) during a given time period and total profit and/or a total profit margin that would be realized by the seller upon acceptance of the plurality of offers.

According to various embodiments, the processor may be further configured to provide the seller with an option to accept all of the plurality of offers with a single selection of an acceptance button.

It is noted that aspects of the invention described with respect to one embodiment may be incorporated in a different embodiment although not specifically described relative thereto. That is, all embodiments and/or features of any embodiment can be combined in any way and/or combination. Applicants reserve the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1A is a schematic illustration of a network that connects buyers and sellers to an electronic exchange, according to various embodiments.

FIG. 1B is a block diagram of the electronic exchange of FIG. 1A, according to various embodiments.

FIG. 1C is a block diagram that illustrates details of an exemplary processor and memory that may be used in accordance with embodiments of the present invention.

FIGS. 2A-2F are flowcharts illustrating operations of the electronic exchange of FIG. 1A, according to various embodiments.

FIG. 3A is a block diagram illustrating transactions between buyers and sellers of FIG. 1A, according to various embodiments.

FIGS. 3B and 3C are block diagrams that illustrate displays of electronic devices of different sellers of FIG. 1A after the different sellers have received one or more offers to purchase a consumer good (e.g., a product or service), according to various embodiments.

FIGS. 4A-4H are block diagrams that illustrate a display of an electronic device of a seller of FIG. 1A after the seller has received a plurality of offers to purchase one or more consumer goods (e.g., products or services), according to various embodiments.

FIG. 5 is a block diagram that illustrates a display of an electronic device of a buyer of FIG. 1A after the buyer has submitted an offer to purchase a consumer good (e.g., a product or service), according to various embodiments.

### DETAILED DESCRIPTION

Specific exemplary embodiments of the inventive concepts now will be described with reference to the accompanying drawings. The inventive concepts may, however, be embodied in a variety of different forms and should not be construed as limited to the embodiments set forth herein. Rather, these embodiments are provided so that this disclosure will be thorough and complete, and will fully convey the scope of the inventive concepts to those skilled in the art. In the drawings, like designations refer to like elements. It will be understood that when an element is referred to as being “connected,” “coupled,” or “responsive” to another element, it can be directly connected, coupled or responsive to the other element or intervening elements may be present. Furthermore, “connected,” “coupled,” or “responsive” as used herein may include wirelessly connected, coupled, or responsive.

The terminology used herein is for the purpose of describing particular embodiments only and is not intended to be limiting of the inventive concepts. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will also be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the present inventive concepts.

It will be understood that the term “consumer good” may be used herein to describe an item identifiable by a Stock-Keeping Unit (SKU), a Universal Product Code (UPC), a Global Trade Identifier Number (GTIN), and/or another unique product (or service) identifier. In other words, a consumer good described herein may be a specific consumer good rather than any one of a number of consumer goods that merely fit a general description (e.g., a size-twelve brown dress shoe). Specifically, the consumer good may be a product, and the brand and/or model name/number of the product may be indicated to a prospective buyer of the product before the prospective buyer makes an offer to purchase the product. Additionally or alternatively, the term “consumer good” may be used herein to describe specific services. In other words, a consumer good described herein may refer to a specific service that will be performed by a specific service provider and/or for an item having a specific brand and/or model name/number. For example, a consumer good described herein may refer to a specific rental car company and/or a specific make/model of a vehicle for which a prospective renter can make a rental offer. As another example, a consumer good described herein may refer to a specific housecleaning company and/or a specific housecleaning service (e.g., a one-time housecleaning or a repeated monthly housecleaning) for which a prospective buyer can make an offer.

It will be understood that the term “demand analytics” may be used herein to describe statistics/metrics of buyer demand for consumer goods (e.g., products or services). Such statistics/metrics may include cost-to-the-seller, wholesale, retail, and/or offer prices for consumer goods, and/or information such as profit/profit margin that is generated using pricing information. The statistics/metrics may additionally or alternatively include information such as a time of receipt of an offer to purchase a consumer good and/or information that identifies a prospective buyer making the offer. Moreover, it will be understood that the term “demand analytics preference” may be used herein to describe a preference of a seller of consumer goods regarding whether and/or how demand analytics are displayed to the seller. The demand analytics may be displayed to the seller as/along with one or more offers to purchase a consumer good and/or may be displayed to the seller as historical information. As an example, a demand analytics preference may determine whether and/or the order in which offers are displayed to a seller.

Exemplary embodiments of the present invention may be embodied as systems, methods, and exchanges. Accordingly, exemplary embodiments of the present invention may be embodied in hardware and/or in software (including firmware, resident software, micro-code, etc.). Furthermore, exemplary embodiments of the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some aspects of the present invention may be implemented in a “cloud” computing environment. Cloud computing is a computing paradigm where shared resources, such as processor(s), software, and information, are provided to computers and other devices on demand typically over a network, such as the Internet. In a cloud computing environment, details of the computing infrastructure, e.g., processing power, data storage, bandwidth, and/or other resources are abstracted from the user. The user does not need to have any expertise in or control over such computing infrastructure resources. Cloud computing typically involves the provision of dynamically scalable and/or virtualized resources over the Internet. A user may access and use such resources through the use of a Web browser. A typical cloud computing provider may provide an online application that can be accessed over the Internet using a browser. The cloud computing provider, however, maintains the software for the application and some or all of the data associated with the application on servers in the cloud, i.e., servers that are maintained by the cloud computing provider rather than the users of the application.

Exemplary embodiments of the present invention are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Imperfect (e.g., imprecise) pricing of consumer goods can result in significant lost profits for retailers and can frustrate potential buyers who are uncomfortable with a listed price and may choose to wait for a sale price instead of paying the listed price. In particular, predicting consumer demand (and thus appropriate pricing) can be expensive, slow, and inaccurate. Moreover, the sale of consumer goods at clearance prices and/or in clearance stores or clearance sections of stores (whether online or in physical stores) can damage the brand equity associated with the consumer goods, especially if the consumer goods have a reputation for being upscale/exclusive goods. Various embodiments of the inventive concepts described herein, however, allow buyers to submit offers on specific consumer goods they want to purchase, and allow retailers to increase profit/profit margins and protect brand equity.

According to various embodiments of facilitating a buyer-driven transaction, a buyer may submit an offer to an electronic exchange for a specific consumer good that the buyer wants to purchase. For example, a buyer may submit an offer to a BuyStand™ Exchange for an item identifiable by a Stock-Keeping Unit (SKU), a Universal Product Code (UPC), a Global Trade Identifier Number (GTIN), and/or another unique product (or service) identifier. In particular, the process of facilitating a buyer-driven transaction may include receiving at the electronic exchange the offer from the buyer to purchase the consumer good at a buyer-determined price. For example, the buyer may submit an offer to pay $40.00 for the consumer good. Accordingly, the electronic exchange provides the buyer with the opportunity to drive pricing for the consumer good based on the buyer's perceived value of the consumer good. The electronic exchange thus may incentivize the buyer to take immediate action toward purchasing the consumer good instead of waiting for a seller to reduce the price of the consumer good. Additionally, according to various embodiments of the present inventive concepts, the buyer may submit the offer either with or without a time limit (e.g., one minute, one hour, or one day) for acceptance of the offer.

Moreover, various embodiments of the present inventive concepts may allow sellers (e.g., retailers and/or manufacturers) to access real-time demand analytics metrics that may help to improve determinations of buyer demand, and may thus help to improve pricing precision and profit/profit margins. In particular, the real-time demand analytics metrics may include precise and timely information on who the actual buyers are, what consumer goods they want, and/or how much they are willing to spend.

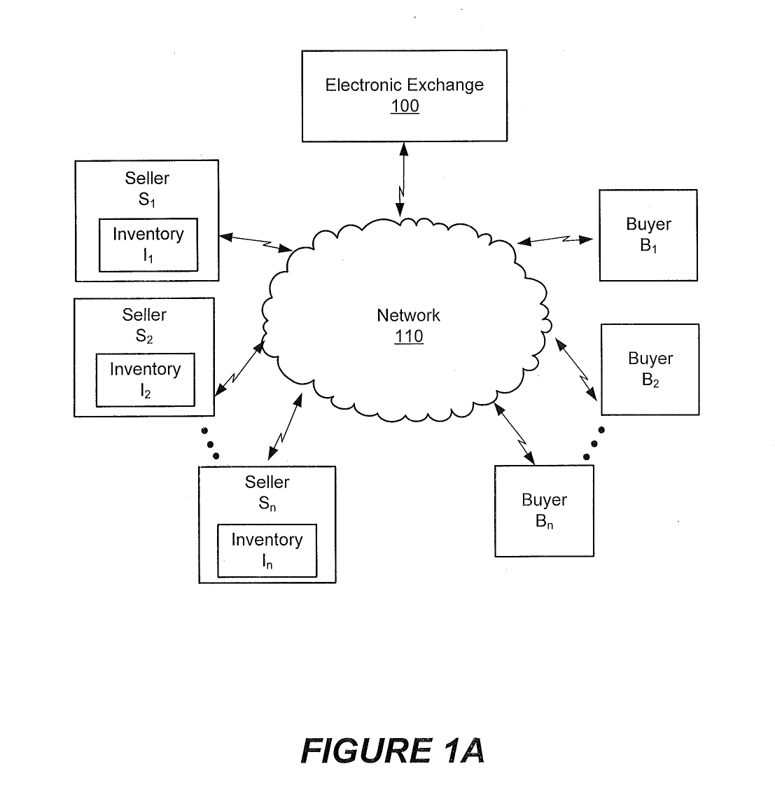

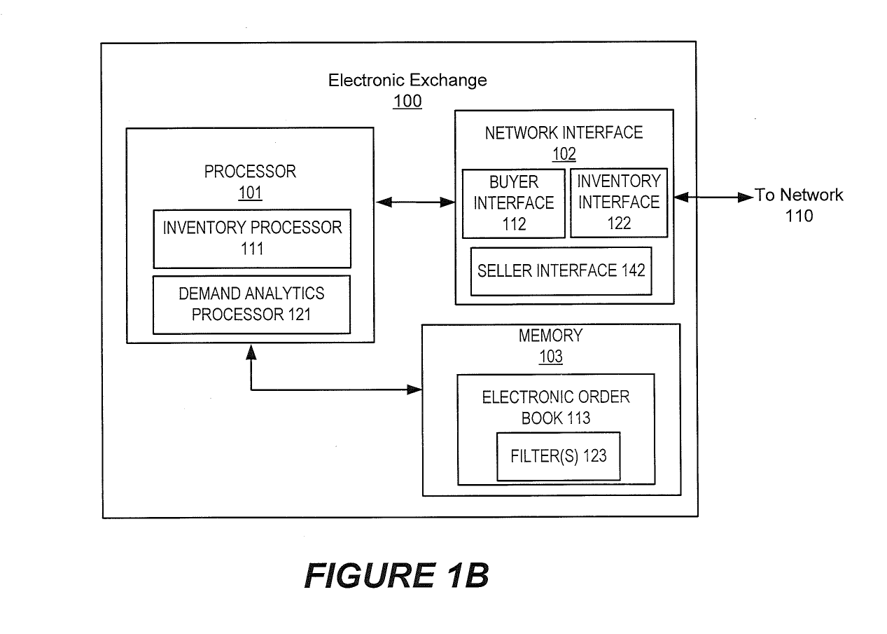

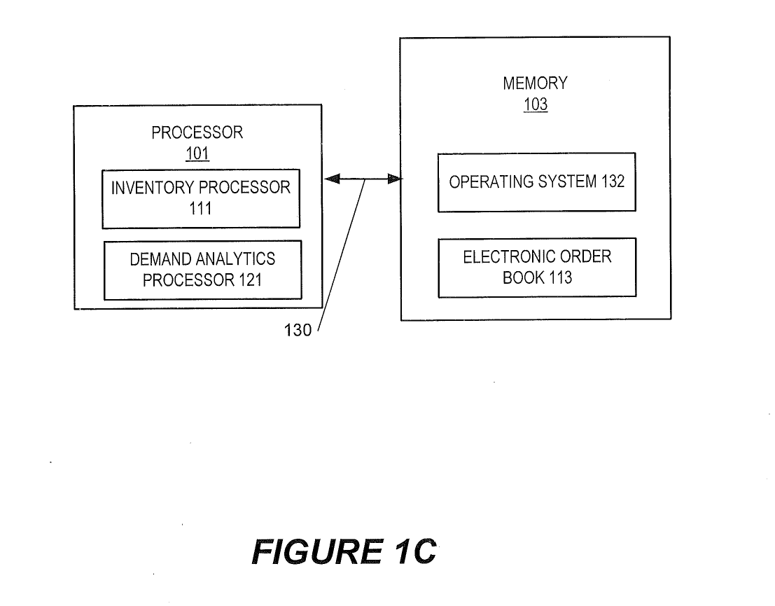

Referring now to FIG. 1A, a schematic illustration is provided of a network 110 that connects buyers B₁-Bₙ and sellers S₁-Sₙ to an electronic exchange 100, according to various embodiments of the present inventive concepts. The network 110 may include the Internet, as well as private networks such as intranets. Additionally or alternatively, the network 110 may include a wireless (e.g., cellular or WLAN) network and/or a wired (e.g., cable or fiber optic) network. The buyers B₁-Bₙ and/or the sellers S₁-Sₙ may connect to the network 110 using electronic devices such as computers, televisions, and/or mobile phones. The computers may include desktop, laptop, netbook, tablet computers, and the like. The sellers S₁-Sₙ may have respective inventories I₁-Iₙ, which may be stored electronically in databases operated by the sellers S₁-Sₙ or by third parties. For example, the sellers S₁-Sₙ may be retailers (or other types of sellers, such as service providers) having respective inventories I₁-Iₙ of consumer goods, which may be stored electronically in servers. Moreover, it will be understood that a buyer B described herein shall refer to any one of the buyers B₁-Bₙ. Similarly, a seller S shall refer to any one of the sellers S₁-Sₙ, and an inventory I shall refer to any one of the inventories I₁-Iₙ. Additionally, the term “inventory” may be used herein to refer to both an inventory of products and a schedule of services provided by a service provider. For example, an inventory I may refer to a housecleaning service's schedule of days, times, personnel, and/or specific services open/available to a prospective buyer B. Accordingly, the term “inventory data” may be used herein to refer to both inventory data for one or more products and to capacity data corresponding to schedule capacity/availability for one or more services/service providers.

Referring now to FIG. 1B, a block diagram is provided of the electronic exchange 100 of FIG. 1A, according to various embodiments. In particular, FIG. 1B illustrates that the electronic exchange 100 may include a network interface 102 that is configured to provide a communication interface with the network 110. The communication interface may be for wired and/or wireless communications with the network 110. The electronic exchange 100 may further include a processor 101 that is coupled to the network interface 102. The processor 101 may be configured to communicate with the buyers B₁-Bₙ and sellers S₁-Sₙ via the network interface 102. For example, the network interface 102 may include a buyer interface 112 for communicating with the buyers B₁-Bₙ. As an example, the buyer interface 112 may be configured to receive offers to purchase consumer goods from the buyers B₁-Bₙ and/or to transmit acceptances by the sellers S₁-Sₙ of the offers to the buyers B₁-Bₙ. The offers from the buyers B₁-Bₙ may be unconditional offers (although they may optionally have respective time limits). In other words, the offers may be binding on the buyers B₁-Bₙ upon the buyers B₁-Bₙ's submissions of the offers, rather than being conditioned upon the buyers B₁-Bₙ's subsequent acceptances of counter-offers from the sellers S₁-Sₙ. The network interface 102 may additionally or alternatively include an inventory interface 122 for receiving inventory data from the inventories I₁-Iₙ and/or a seller interface 142 for transmitting offers to the sellers S₁-Sₙ and/or receiving acceptances of the offers. Moreover, it will be understood that the buyer interface 112, the seller interface 142, and the inventory interface 122 may be separate interfaces or may be combined as a single interface.

The processor 101 may include an inventory processor 111 configured to process inventory data received from the inventories I₁-Iₙ through the inventory interface 122. The processor 101 may additionally or alternatively include a demand analytics processor 121. The inventory processor 111 and the demand analytics processor 121 may be separate processors or may be combined as a single processor. In some embodiments, the demand analytics processor 121 may be distributed among multiple processors.

The demand analytics processor 121 may be configured to perform of variety of demand analytics processing tasks. For example, the demand analytics processor 121 may be configured to determine whether to make an offer available to a particular seller S after the electronic exchange 100's inventory processor 111 matches the offer with the seller S, based on at least one demand analytics preference of the seller S for the consumer good. A demand analytics preference for a consumer good may include a preference regarding profit/profit margin, raw price, time of receiving an offer, etc. For example, the demand analytics preference may be to only include offers with raw prices or profits/profit margins above a threshold level. In another example, the demand analytics preference may be to include only the highest offer or the most recent offer, or a group of top/recent offers.

The demand analytics processor 121's determination regarding whether to make an offer available to a particular seller S may be made automatically by the electronic exchange 100 without requiring additional input from the seller S beyond a previous input of a demand analytics preference. Alternatively, the seller S may initially receive all offers for which the seller S has a corresponding item in its inventory I, and the seller S may subsequently manually apply its demand analytics preference(s) to filter the offers.

Additionally or alternatively, the demand analytics processor 121 may be configured to adjust whether an offer is made available to a seller S and/or how the offer is communicated (e.g., displayed) to the seller S, in response to an adjustment by the seller S of a demand analytics preference for the consumer good. As an example, the seller S may change the demand analytics preference from a default/previous setting and then select (e.g., click/touch) an “optimize” button within a user interface displayed on a website or mobile application or in an email or other electronic message, to optimize a plurality of offers in real-time based on the demand analytics preference.

The electronic exchange 100 may also include a memory 103 that is coupled to the processor 101. The memory 103 may include an electronic order book 113 that receives and stores offers from the buyers B₁-Bₙ to purchase consumer goods at prices determined by the buyers B₁-Bₙ. For example, the electronic order book 113 may be configured to receive, via the network interface 102, an offer from a buyer B to purchase a consumer good at a buyer-determined price. As an example, the buyer B may submit an offer to purchase a golf club at a buyer-determined price of $40.00. The buyer-determined price may be a price entered using a user interface of an electronic device used by the buyer B. As an example, the buyer B may enter or select a buyer-determined price of $40.00 using a keypad, touch screen, cursor, or microphone. The electronic order book 113 may also receive and store inventory data corresponding to the sellers S₁-Sₙ. For example, the inventory data may include inventory data received from the inventories I₁-Iₙ. Moreover, the inventory processor 111 may be configured to search seller inventory data to match the buyer B's offer with at least one seller inventory I that includes the consumer good. For example, the inventory processor 111 may be configured to search for (or filter/process) inventory data in the electronic order book 113 or inventory data external to the electronic exchange 100 to match the buyer B's offer with at least one seller inventory I. Furthermore, the electronic order book 113 may be configured to receive, via the network interface 102, an acceptance of the buyer B's offer from an individual seller S, such as the seller S₁.

The electronic order book 113 may include, or may operate in conjunction with, one or more filters 123, which may store demand analytics preferences for the sellers S₁-Sₙ and/or instructions/algorithms for applying the demand analytics preferences. The filter(s) 123 may be configured to optimize a plurality of offers that match a seller inventory I of a particular seller S, based on one or more demand analytics preferences of the seller S for a consumer good. The optimization may include determining, using the demand analytics preference(s), whether to make the plurality of offers available to the seller S and/or how to communicate (e.g., display) the plurality of offers to the seller S. As an example, optimizing the plurality of offers may include sorting the plurality of offers based on at least one of profit/profit margin for the seller S with respect to the consumer good at the plurality of buyer-determined prices and a comparison of raw prices of the plurality offers for the consumer good. For example, the optimization may include making only the top twenty (20) offers available to the seller S and/or may include ranking/displaying the offers in descending order, based on the times of receipt or the raw prices or profits/profit margins of the offers.

Referring still to FIG. 1B, the memory 103 may also store instructions/algorithms used to match offers from the buyers B₁-Bₙ and inventory data received from the inventories I₁-Iₙ. For example, the instructions/algorithms may be used to compare and link together offers from the buyers B₁-Bₙ and inventory data received from the inventories I₁-Iₙ. Moreover, it will be understood that the electronic exchange 100 may include a single processor or a combination of processors. In particular, the electronic exchange 100 may be used in a cloud computing environment. For example, the electronic order book 113 may be distributed/stored among different servers/processors.

FIG. 1C is a block diagram that illustrates details of an exemplary processor and memory that may be used in accordance with embodiments of the present invention.

FIG. 1C illustrates an exemplary processor 101 and memory 103 of an electronic exchange 100, according to some embodiments of the present invention. The processor 101 communicates with the memory 103 via an address/data bus 130. The processor 101 may be, for example, a commercially available or custom microprocessor. Moreover, it will be understood that the processor may include multiple processors. The memory 103 is representative of the overall hierarchy of memory devices containing the software and data used to implement various functions of an electronic exchange 100 as described herein. The memory 103 may include, but is not limited to, the following types of devices: cache, ROM, PROM, EPROM, EEPROM, flash, SRAM, and DRAM.

As shown in FIG. 1C, the memory 103 may hold various categories of software and data, such as an operating system 132 and/or an electronic order book 113. The operating system 132 controls operations of an electronic exchange 100. In particular, the operating system 132 may manage the resources of the electronic exchange 100 and may coordinate execution of various programs (e.g., the electronic order book 113) by the processor 101.

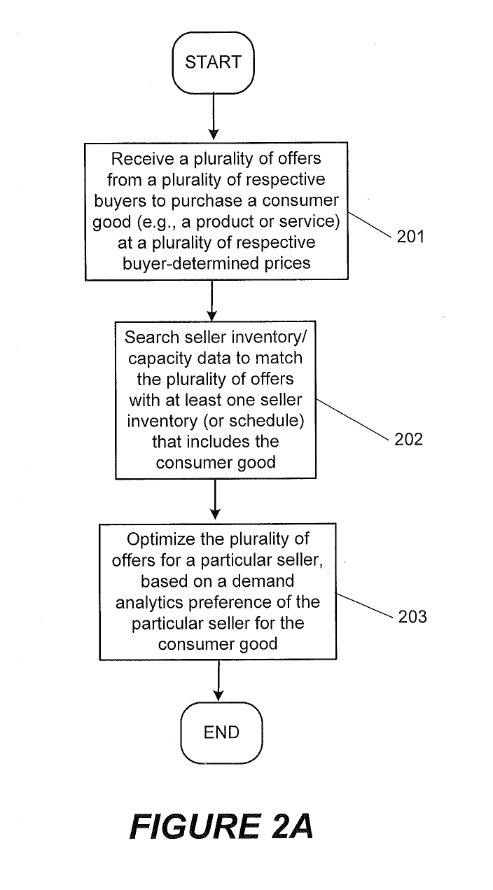

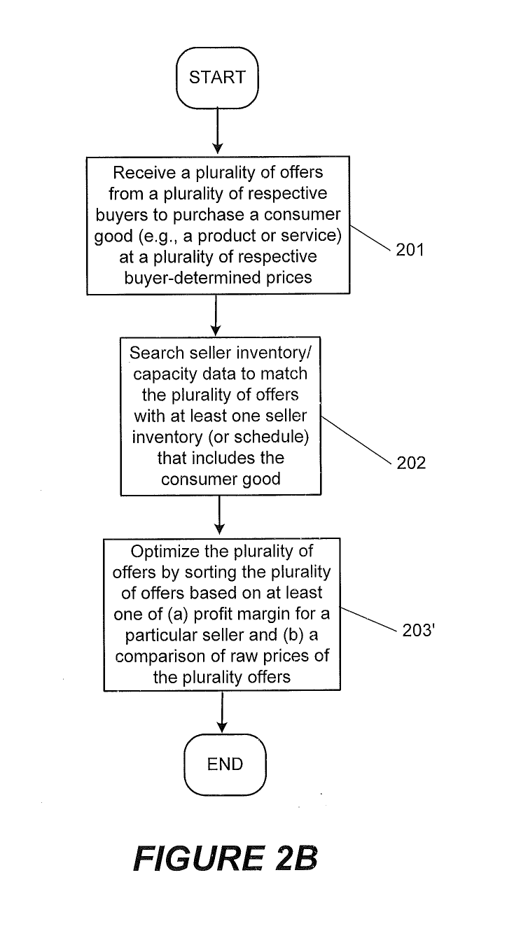

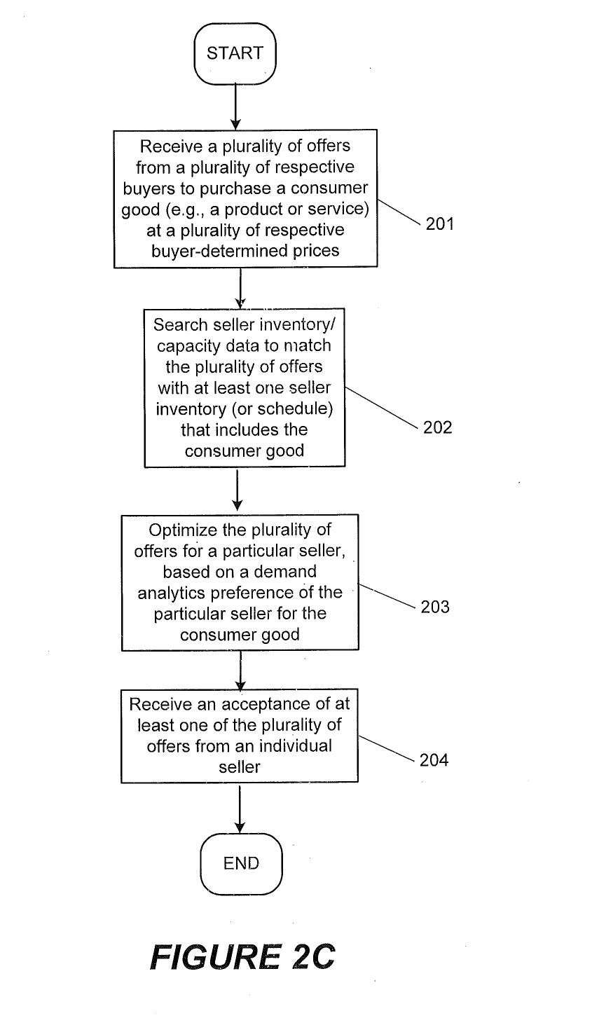

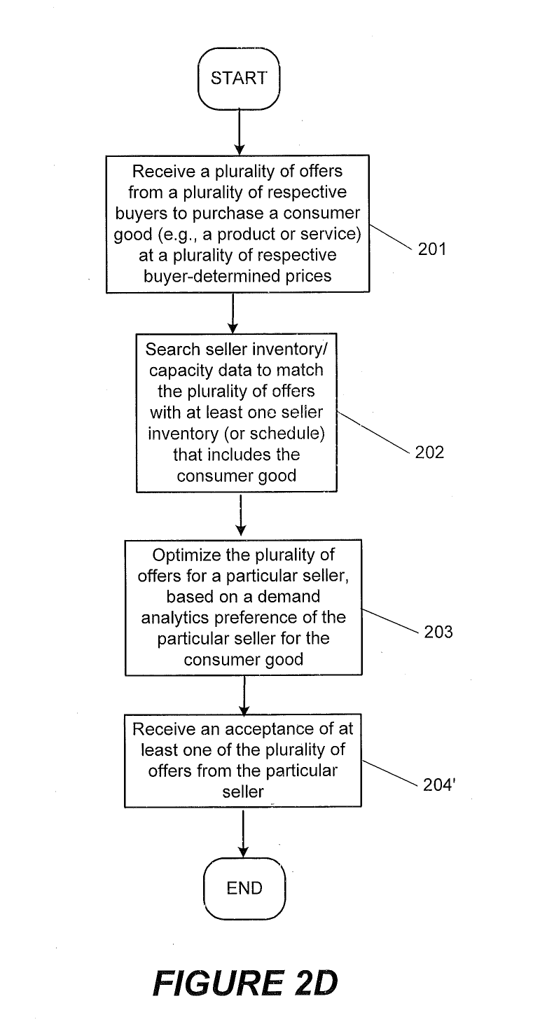

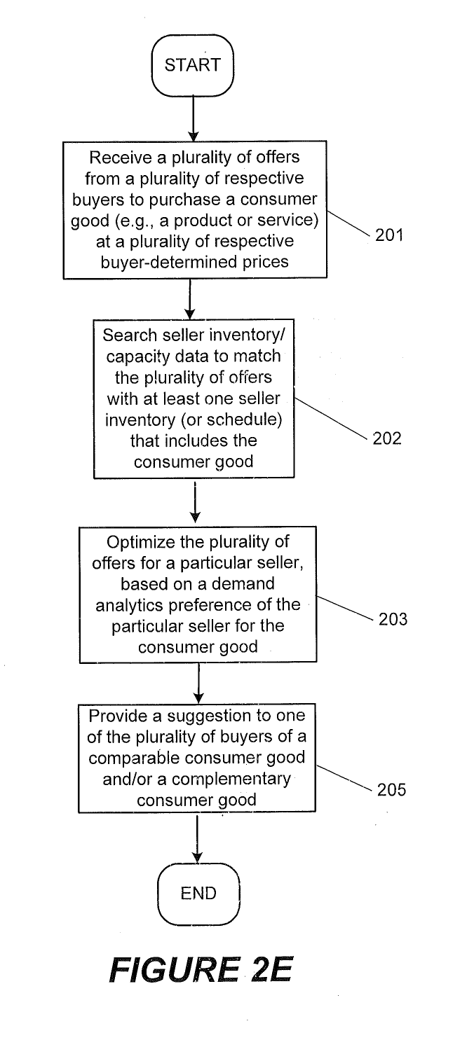

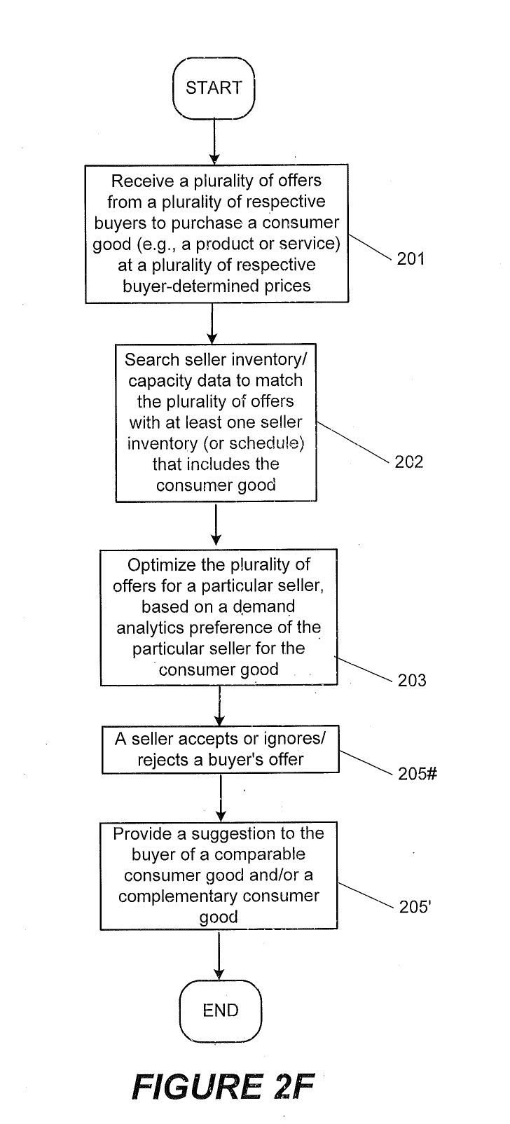

FIGS. 2A-2F are flowcharts illustrating operations of the electronic exchange 100 of FIG. 1A, according to various embodiments. Referring now to FIG. 2A, operations of the electronic exchange 100 may include receiving at the electronic exchange 100 a plurality of offers from a plurality of respective buyers B₁-Bₙ to purchase a consumer good at a plurality of respective buyer-determined prices (Block 201). The operations of the electronic exchange 100 may also include searching seller inventory data from at least one database to match the plurality of offers with at least one seller inventory (e.g., at least one of the inventories I₁-Iₙ) that includes the consumer good (Block 202). The operations of the electronic exchange 100 may further include using the demand analytics processor 121 and/or one or more of the filters 123 to optimize the plurality of offers that match a particular seller inventory I, for a particular seller S (Block 203). Optimizing the offers may include determining whether to make the plurality of offers available to the seller S and/or how to communicate (e.g., display) the plurality of offers to the seller S, based on a demand analytics preference of the seller S for the consumer good.

Referring now to FIG. 2B, FIG. 2B includes Blocks 201 and 202 of FIG. 2A, and further includes Block 203′, which is a modification of Block 203 of FIG. 2A. In particular, Block 203′ indicates that optimizing the plurality of offers may include sorting the plurality of offers based on at least one of (a) profit margin for the particular seller S with respect to the consumer good at the plurality of buyer-determined prices and (b) a comparison of raw prices of the plurality offers for the consumer good.

Referring now to FIG. 2C, FIG. 2C includes Blocks 201-203 of FIG. 2A, and further includes Block 204. Block 204 indicates receiving, at the electronic exchange 100, an acceptance of at least one of the plurality of offers from an individual one of the sellers S₁-Sₙ having a corresponding one of the seller inventories I₁-Iₙ that the electronic exchange 100 has matched with the plurality of offers.

Referring now to FIG. 2D, FIG. 2D includes Blocks 201-203 of FIG. 2C, and further includes Block 204′, which is a modification of Block 204 of FIG. 2C. In particular, Block 204′ indicates that the individual one of the sellers S₁-Sₙ accepting at least of the offers is the particular seller S for whom the plurality of offers were optimized in Block 203.

Referring now to FIG. 2E, FIG. 2E includes Blocks 201-203 of FIG. 2A, and further includes Block 205, which indicates providing a suggestion to one of the plurality of buyers B₁-Bₙ. The suggestion may be of a comparable consumer good with respect to the consumer good and/or a complementary consumer good with respect to the consumer good. For example, if a buyer B makes an offer for a golf club, then the demand analytics processor 121 may generate a suggestion that the buyer B make an offer to purchase a comparable golf club. The comparable golf club may be a similar golf club by the same manufacturer or by a different manufacturer, and will have a different SKU, UPC, GTIN, and/or other unique product identifier from the golf club for which the buyer B has already made an offer. Additionally or alternatively, the demand analytics processor 121 may generate a suggestion that the buyer B make an offer to purchase a golf bag (or golf balls, etc.) that would complement the golf club for which the buyer B has made an offer. The demand analytics processor 121 may suggest the complementary consumer good in response to submission or acceptance of the buyer B's offer to purchase the golf club, or in response to the buyer B's viewing/selecting the consumer good. The comparable/complementary good suggestion(s) may be displayed to the buyer B in an email, Short Message Service (SMS), or Multimedia Messaging Service (MMS) message or in an indication on a seller website or mobile application. As an example, the suggestion(s) may be displayed to the buyer B via a “Make An Offer” button.

Referring now to FIG. 2F, FIG. 2F includes Blocks 201-203 of FIG. 2E, and further includes Blocks 205# and 205′, which are modifications of Block 205 of FIG. 2E. In particular, FIG. 2F illustrates providing a suggestion to a buyer B (Block 205′) in response to at least one of (a) acceptance of an offer from the buyer B by an individual seller S whose inventory I has been matched with the plurality of offers and (b) rejection of the offer by the individual seller S (Block 205#). Moreover, it will be understood that rejection of the offer by the individual seller S may include ignoring the offer, explicitly declining the offer, or otherwise not accepting the offer (such as not accepting the offer before it expires).

Additionally or alternatively, the electronic exchange 100 may determine that the buyer B has failed to submit an offer after viewing (either electronically or in a physical store) a consumer good for a threshold amount of time. In the event of the buyer B's failure to submit an offer within the threshold time, the demand analytics processor 121 may suggest a comparable consumer good to the buyer B before the buyer B submits an initial offer for the consumer good (or even if the buyer never submits an offer).

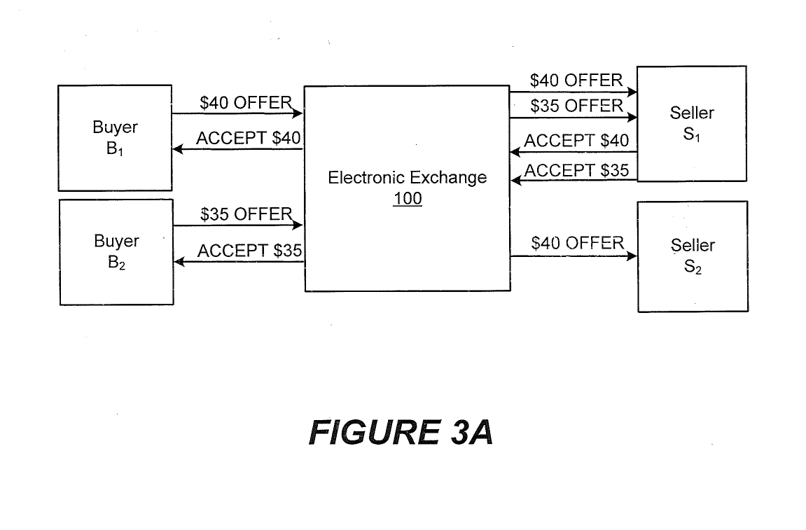

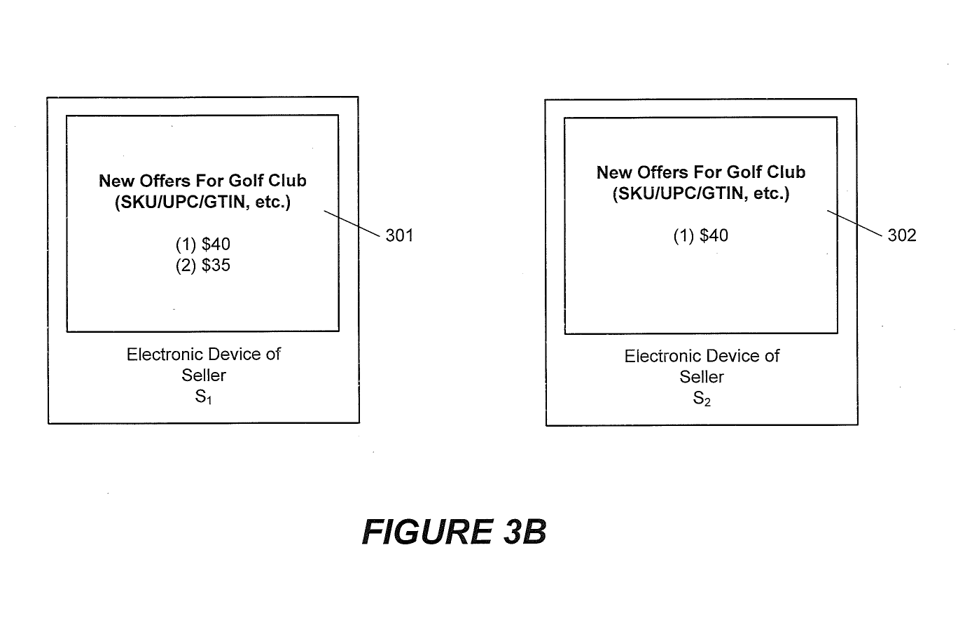

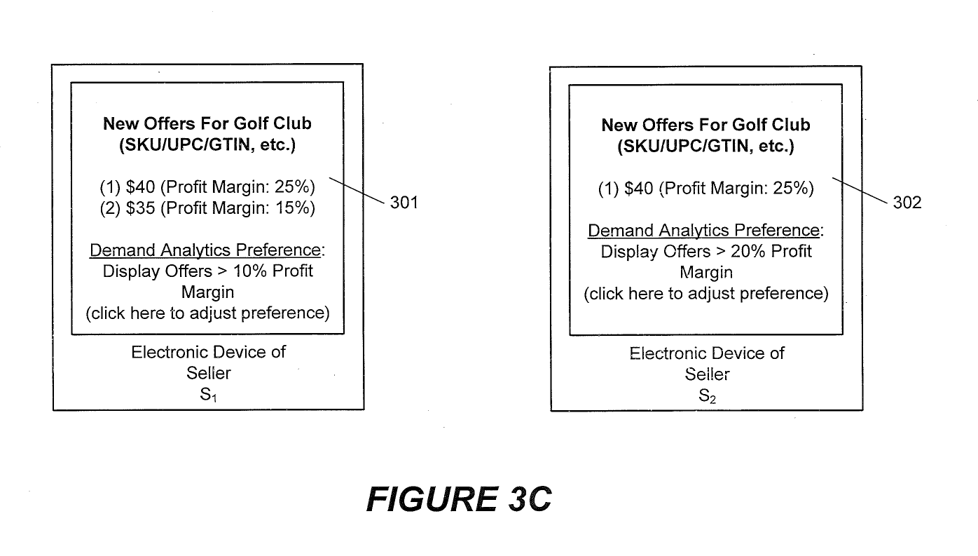

Referring now to FIG. 3A, a block diagram is provided illustrating transactions between buyers B₁ and B₂ and sellers S₁ and S₂ of FIG. 1A, according to various embodiments. In particular, FIG. 3A illustrates that the buyers B₁ and B₂ submit offers to the electronic exchange 100 to purchase a consumer good at buyer-determined prices of $40.00 and $35.00, respectively. FIG. 3A further illustrates that the electronic exchange 100 determines that the inventory I₁ of the seller S₁ includes the consumer good, and that a demand analytics preference of the seller S₁ allows both the $40.00 offer and the $35.00 offer to be made available to the seller S₁. For example, the electronic exchange 100 may determine, using the demand analytics preference of the seller S₁, to transmit the offers to the seller S₁ such that the offers may be displayed on an electronic device of the seller S₁. In contrast, only the $40.00 offer (and not the $35.00 offer) may be sufficient to satisfy a more strict demand analytics preference of the seller S₂, after the electronic exchange 100 determines that the inventory I₂ of the seller S₂ includes the consumer good.

If the seller S₁ accepts both the $40.00 offer and the $35.00 offer, then the seller S₁ may transmit its acceptance of the offers to the electronic exchange 100. The electronic exchange 100 may then provide an indication to the buyer B₁ that the seller S₁ has accepted the buyer B₁'s $40.00 offer, as well as an indication to the buyer B₂ that the seller S₁ has accepted the buyer B₂'s $35.00 offer. Moreover, it will be understood that the electronic exchange 100 may prevent the seller S₂ from accepting the buyer B₁'s $40.00 offer after the seller S₁ has accepted the buyer B₁'s $40.00 offer.

FIGS. 3B and 3C are block diagrams that illustrate displays of electronic devices of different sellers S₁ and S₂ of FIG. 1A after the different sellers S₁ and S₂ have received one or more offers to purchase a consumer good, according to various embodiments. Referring now to FIG. 3B, as described with respect to FIG. 3A, buyers B₁ and B₂ may submit offers to the electronic exchange 100 to purchase a consumer good at buyer-determined prices of $40.00 and $35.00, respectively. In particular, the offers may be for a golf club corresponding to a particular SKU, UPC, GTIN, and/or other unique product identifier. After determining that the inventories I₁ and I₂ of the sellers S₁ and S₂, respectively, each include the consumer good, the electronic exchange 100 may use respective demand analytics preferences of the sellers S₁ and S₂ to determine whether/how to communicate (e.g., display) the offers to the sellers S₁ and S₂. For example, FIG. 3B illustrates that a demand analytics preference of the seller S₁ dictates that both the $40.00 offer and the $35.00 offer may be provided to a display 301 of the electronic device of the seller S₁. In contrast, a more strict demand analytics preference of the seller S₂ dictates that only the $40.00 offer (and not the $35.00 offer) may be provided to a display 302 of the electronic device of the seller S₂. The display 301 or the display 302 may display information from the electronic exchange 100 that is in an email, SMS, or MMS message or on a website or mobile application.

Referring now to FIG. 3C, the electronic exchange 100 may be configured to calculate and/or provide profit margin information that will be indicated along with offers provided to the sellers S₁ and S₂. For example, the display 301 of the electronic device of the seller S₁ may indicate that a $40.00 offer has been received by the electronic exchange 100 and would give the seller S₁ a profit margin of 25%, as well as that a $35.00 offer has been received and would give the seller S₁ a profit margin of 15%. The electronic exchange 100 may also determine, either using its own default setting(s) or using a demand analytics preference of the seller S₁, that the display 301 of the electronic device of the seller S₁ will display the offers in descending price order. The display 302 of the electronic device of the seller S₂, on the other hand, may only indicate that the $40.00 offer (and not the $35.00 offer) has been received by the electronic exchange 100, because the $35.00 offer may not satisfy a demand analytics preference of the seller S₂.

Additionally or alternatively to indicating profit margins corresponding to received offers, the electronic exchange 100 may be configured to indicate one or more analytics preferences to the sellers S₁ and S₂. For example, the display 301 of the electronic device of the seller S₁ may indicate that the seller S₁ has a demand analytics preference that only offers providing a profit margin of greater than 10% will be displayed to the seller S₁. The display 301 may further indicate (e.g., via a clickable/touchable button) that a user of the electronic device of the seller S₁ may use a user interface of the electronic device to adjust the demand analytics preference. In contrast, the display 302 of the electronic device of the seller S₂ may indicate that a demand analytics preference of the seller S₂ is to only display offers that will provide a profit margin of greater than 20%, which is why the $35.00 offer corresponding to a 15% profit margin is not displayed on the display 302.

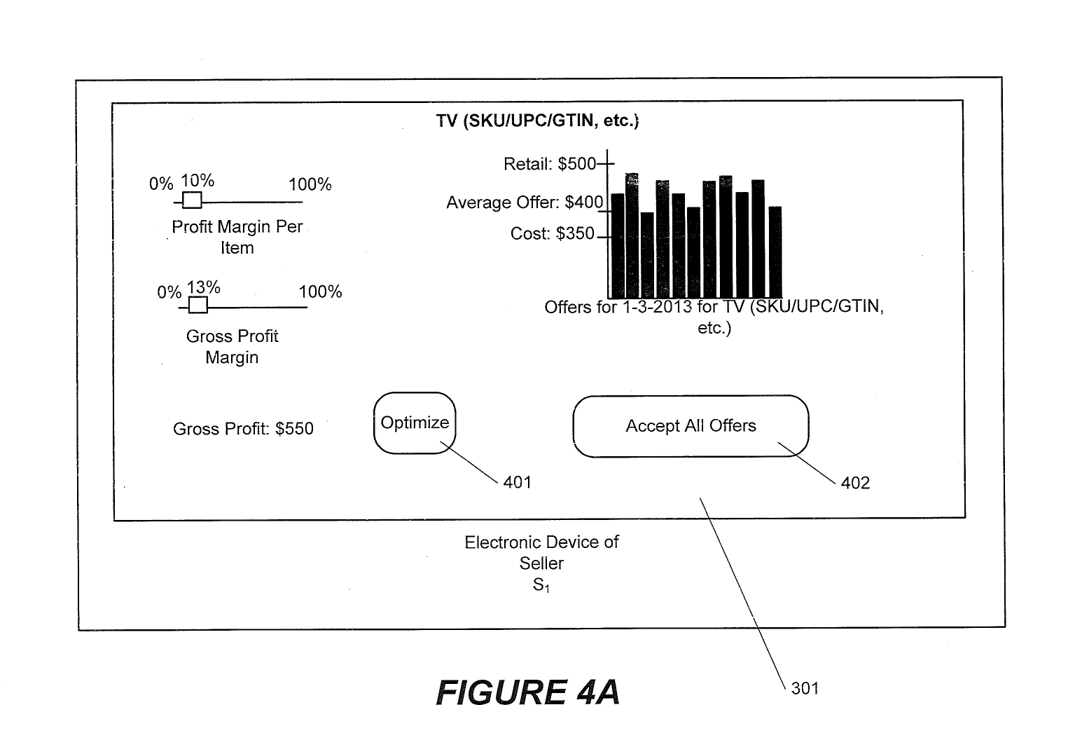

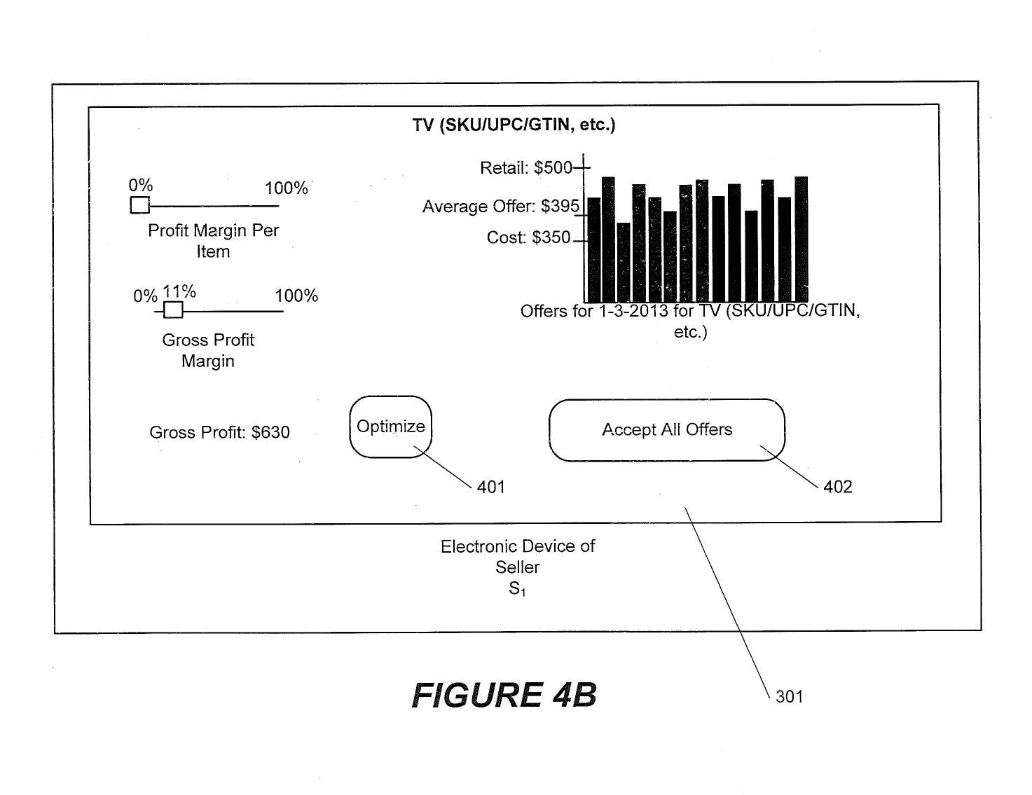

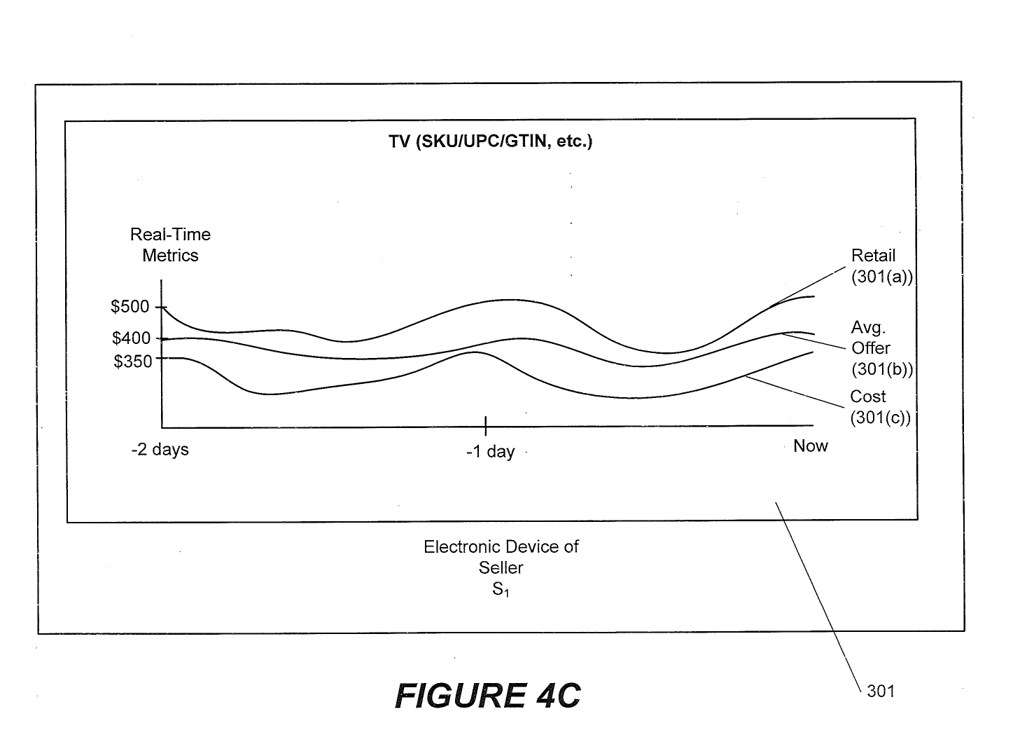

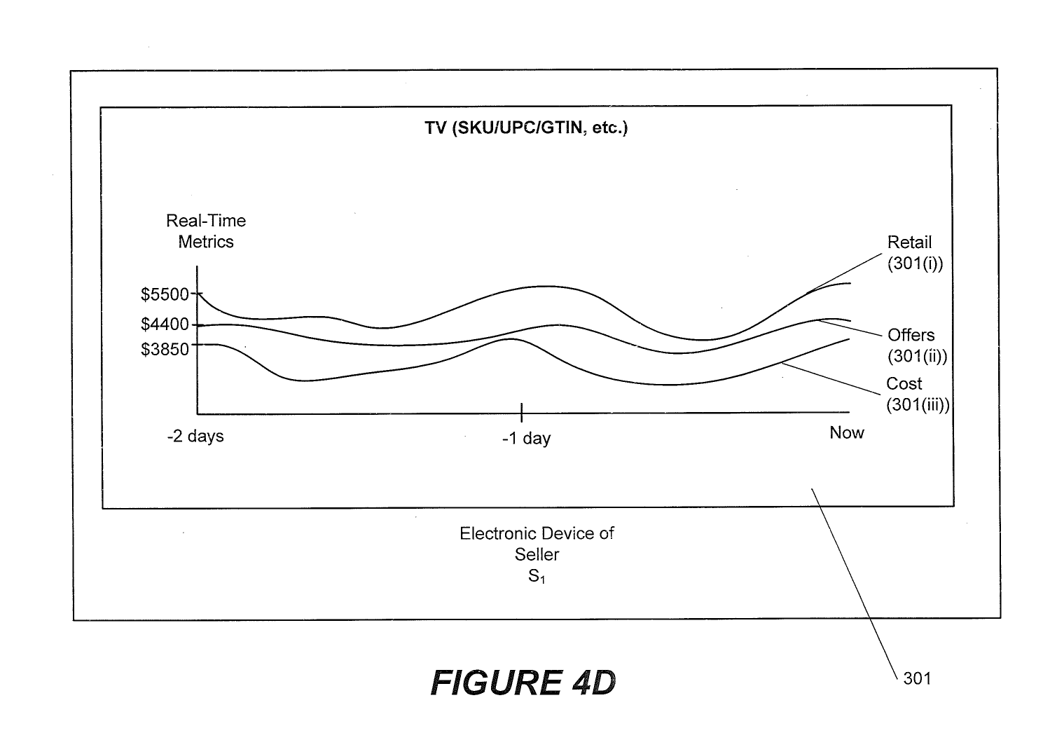

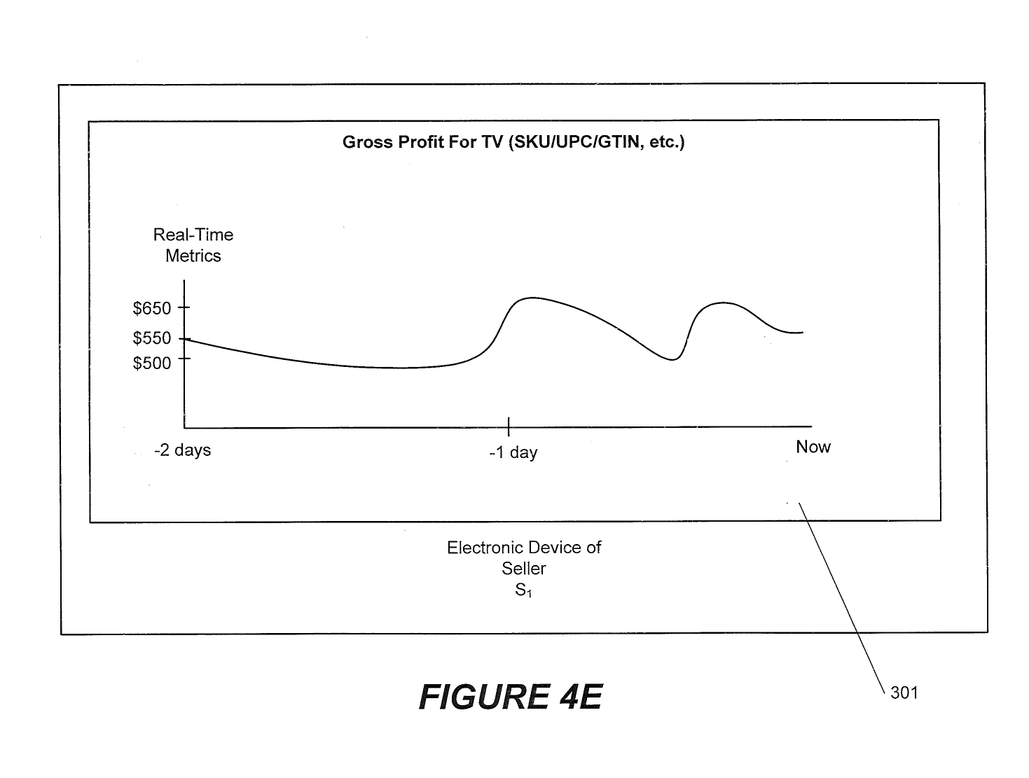

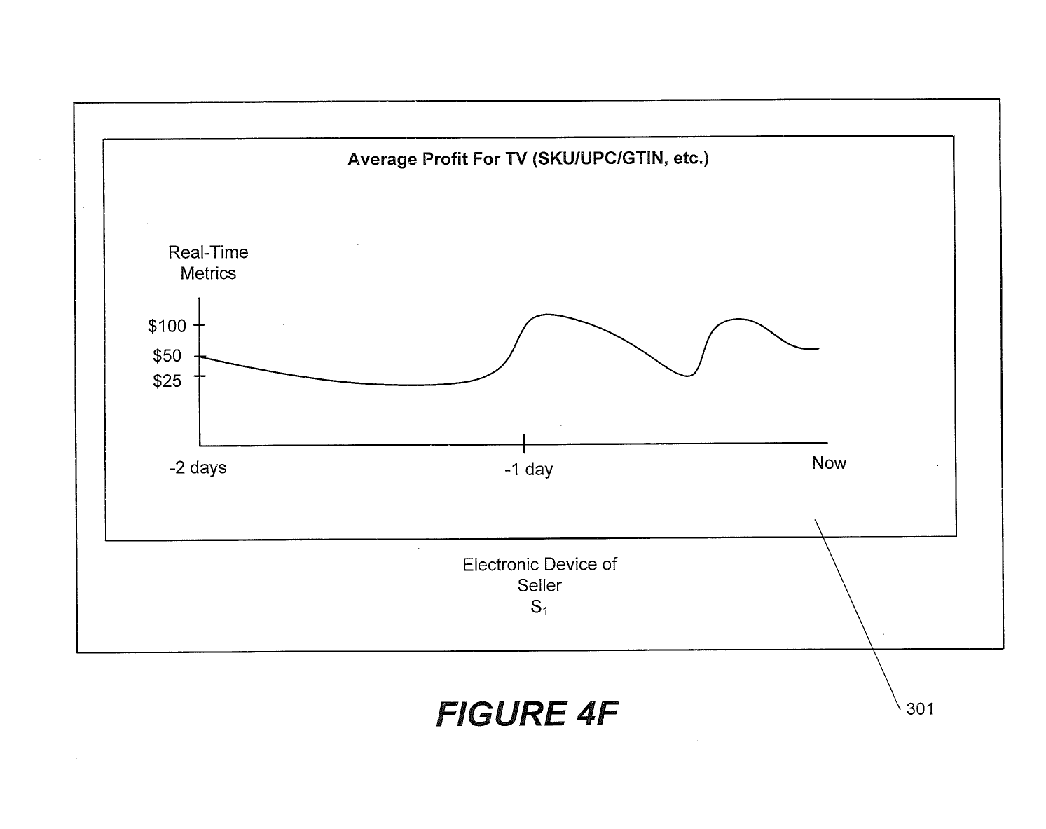

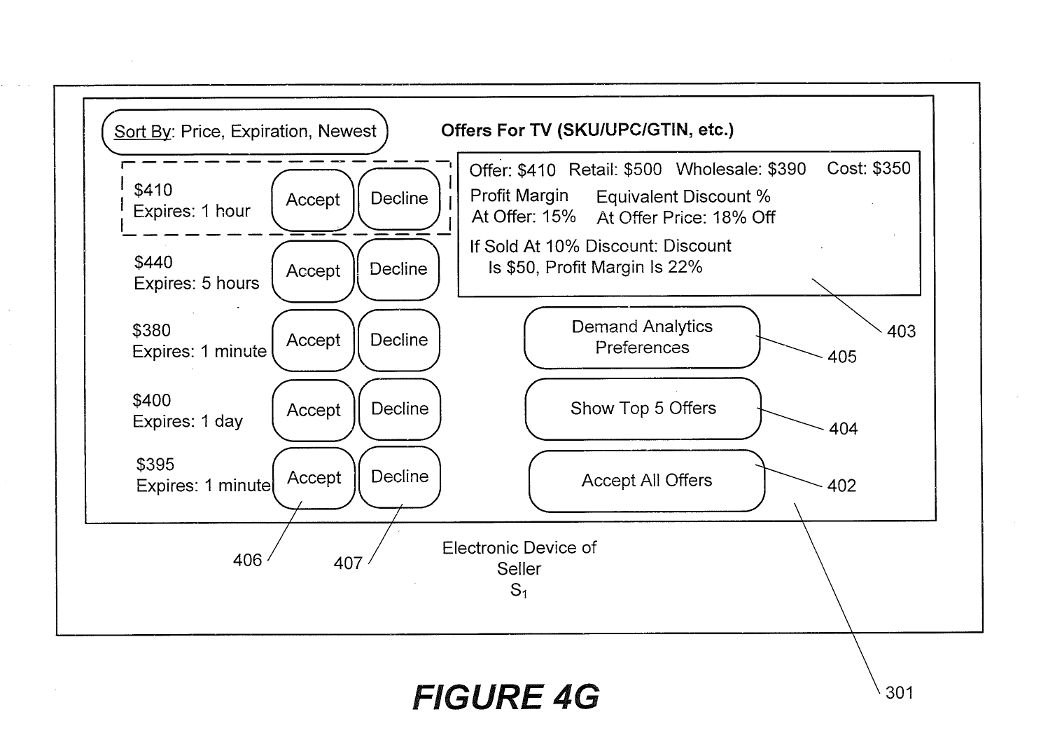

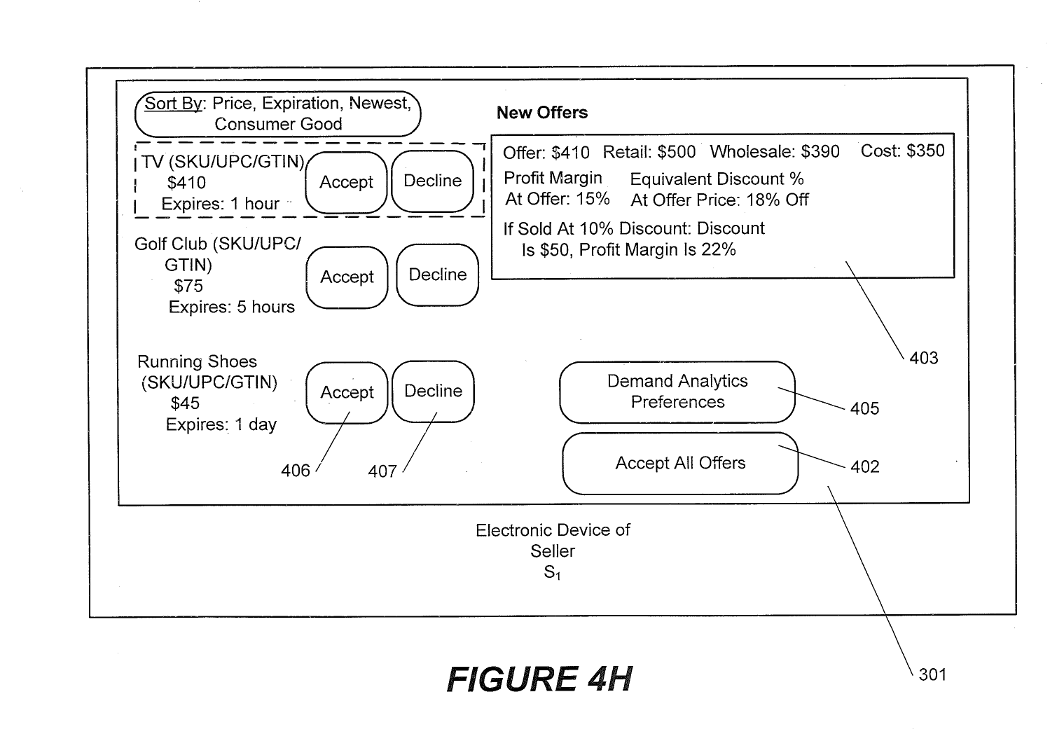

FIGS. 4A-4H are block diagrams that illustrate a display of an electronic device of a seller S of FIG. 1A after the seller S has received a plurality of offers to purchase one or more consumer goods, according to various embodiments. Referring now to FIG. 4A, the electronic exchange 100 may be configured to provide a variety of demand analytics metrics/information to the display 301 of an electronic device of a seller S₁. The demand analytics metrics/information may be for a television (TV) that corresponds to a particular SKU, UPC, GTIN, and/or other unique product identifier. Each unit of the TV may cost the seller S₁ $350, and the TV may have a retail price of $500. The display 301 may indicate the TV's retail price, cost to the seller S₁, and/or average offer from the buyers B₁-Bₙ for a given day (e.g., Jan. 3, 2013) or hour, etc. The electronic exchange 100 may additionally or alternatively provide to the display 301 of the seller S₁ information/preferences regarding the gross profit for all of the offers for the TV, the gross profit margin for all of the offers for the TV, and/or the profit margin per item/unit of the TV. For example, a demand analytics preference of the seller S₁ may dictate that only offers providing at least a 10% profit margin will be provided from the electronic exchange 100 to the seller S₁. As a result, the offers displayed on the display 301 may provide a gross profit margin of 13% (which satisfies the demand analytics preference of at least 10%) and a gross profit of $550.

Moreover, the electronic exchange 100 may provide the seller S₁ with an option to accept all of the offers provided/displayed to the seller S₁ for the TV, to realize the gross profit of $550. For example, the demand analytics processor 121 may be configured to provide the seller S₁ with an option to accept all of the offers with a single selection of an acceptance button, such as an “Accept All Offers” button 402. Accordingly, the seller S₁ may have the option to manually accept the offers. Additionally or alternatively, the seller S₁ may have the option to use a seller selection algorithm that automatically accepts or rejects the offers for the seller S₁, which allows the seller S₁ to accept or reject the offers without having to use a graphical user interface or to otherwise make a manual selection. For example, it will be understood that the operations of Block 205# in FIG. 2F may be performed automatically using a seller selection algorithm.

Additionally or alternatively, the demand analytics processor 121 may provide the seller S₁ with an option to adjust one or more demand analytics preferences with respect to offers for the TV. For example, the display 301 may display an “Optimize” button 401. As an example, a user of the electronic device of the seller S₁ may slide an indicator on the display 301 corresponding to profit margin per item from 10% to 0%. Utilizing the “Optimize” button 401 may then provide a new set of offers to the seller S₁ by recalculating values of gross profit margin, gross profit, average offer amount, etc. in real time. Alternatively, the “Optimize” button 401 may open a separate interface that allows the user to modify one or more demand analytics preferences. In yet another example, the offers may initially be displayed on the display 301 without applying any demand analytics preferences, and subsequently selecting the “Optimize” button 401 may apply the demand analytics preference(s) of the seller S₁.

Referring now to FIG. 4B, a block diagram is provided of the display 301 of an electronic device of the seller S₁ after a user of the electronic device has adjusted a demand analytics preference for the profit margin per item of the TV from 10% (in FIG. 4A) to 0%. As a result of adjusting the demand analytics preference for the profit margin per item to 0%, all offers will be provided to the seller S₁. Additionally or alternatively, the demand analytics processor 121 may provide a “Display All Offers” button to the seller S₁. FIG. 4B illustrates that adjusting the demand analytics preference for the profit margin per item from 10% to 0% results in a decline of the gross profit margin from 13% to 11%, a decline in the average offer amount for the TV from $400 to $395, and an increase in the gross profit from $550 to $630. Moreover, although FIGS. 4A and 4B illustrate an example of decreasing a demand analytics preference for the profit margin per item from 10% to 0%, it will be understood that a demand analytics preference may be either increased or decreased, and that such an increase or decrease may be either larger or smaller than 10%.

FIGS. 4C-4H illustrate real-time demand analytics metrics provided by the demand analytics processor 121 for a seller S. In particular, in addition to filtering offers for the sellers S₁-Sₙ and providing suggestions to the buyers B₁-Bₙ, the demand analytics processor 121 may be further configured to determine real-time demand information (e.g., metrics, statistics, etc.) regarding a consumer good and to provide the real-time demand information to a seller S. For example, the real-time demand information may include a plurality of offers from a plurality of the buyers B₁-Bₙ for the consumer good during a given time period and total profit and/or a total profit margin that would be realized by the seller S upon acceptance of the plurality of offers. As an example, the seller S may be provided with a list of all offers for a specific golf club during the past minute (or past hour, etc.), as well as an indication of the total profit/profit margin that the seller S would realize upon acceptance of all of the offers. Moreover, the seller S may be provided with historical information, such as comparisons (e.g., in terms of quantity, raw price, profit/profit margin, etc.) of current offers with offers from the previous day, week, month, etc. The historical information may also indicate (e.g., via a chart/graph) changes over time in retail pricing (e.g., MSRP) vs. buyer-offer pricing vs. seller cost.

Referring now to FIG. 4C, a block diagram is provided of the display 301 of an electronic device of a seller S₁. In particular, the display 301 indicates real-time metrics in the form of a graph of changes over a few days in (a) per-unit retail prices, (b) average offer prices, and (c) per-unit cost to the seller S₁ for a TV corresponding to a particular SKU, UPC, GTIN, and/or other unique product identifier. Referring now to FIG. 4D, the display 301 indicates real-time metrics in the form of a graph of changes over a few days in total/gross (i) retail prices, (ii) offer prices, and (iii) cost to the seller S₁ for a TV corresponding to a particular SKU, UPC, GTIN, and/or other unique product identifier. Moreover, referring now to FIGS. 4E and 4F, graphs of changes over a few days in gross profit and average profit per unit, respectively, are illustrated for a TV corresponding to a particular SKU, UPC, GTIN, and/or other unique product identifier.

Referring now to FIG. 4G, a block diagram is provided of the display 301 of an electronic device of a seller S₁ after the seller S₁ has received a plurality of offers to purchase a TV corresponding to a particular SKU, UPC, GTIN, and/or other unique product identifier. The information displayed on the display 301 may be calculated and/or provided to the electronic device of the seller S₁ by the demand analytics processor 121 of the electronic exchange 100. Each offer may be accompanied by an “Accept” button 406 by which the seller S₁ may accept the offer, a “Decline” button 407 by which the seller S₁ may decline/reject the offer, and/or an indication of the time at which the offer expires. The expiration time may be indicated in terms of seconds, minutes, hours, days, etc. The display 301 may display a “Demand Analytics Preferences” button 405 by which the seller S₁ may access and view/modify a menu of demand analytics preferences. Additionally or alternatively, the display 301 may display an “Accept All Offers” button 402 and/or a button by which the demand analytics processor 121 may be commanded to show the seller S₁ only a certain number of top (e.g., highest-priced offers), such as a “Show Top 5 Offers” button 404. Moreover, it will be understood that the seller S₁ may make selections on the display 301 to use the demand analytics processor 121 to sort the offers by price, expiration time, and/or newest offer(s), etc.

The demand analytics processor 121 may additionally or alternatively provide a variety of financial information 403 corresponding to a given offer. For example, a user of the electronic device of the seller S₁ may click/touch one of the offers to display the financial information 403. The financial information 403 may include the (a) offer price, (b) retail price, (c) wholesale price, (d) cost of the TV to the seller S₁, (e) profit margin at the offer price, (f) equivalent discount with respect to the retail price at the offer price, and/or (g) an example of what the profit margin would be at a different discount level with respect to the retail price. Moreover, the demand analytics processor 121 may provide information to the seller S regarding a buyer B making a particular offer. For example, the information may include the buyer B's age, gender, city/state, and/or other offers for consumer goods that are in the seller S₁'s inventory I₁. The demand analytics processor 121 may thus provide the seller S₁ with precise and timely information regarding who the buyer B is, what consumer goods the buyer B wants, and/or how much the buyer B is willing to spend.

Referring now to FIG. 4H, a block diagram is provided of the display 301 of an electronic device of a seller S₁ after the seller S₁ has received offers to purchase a plurality of different consumer goods corresponding to respective SKUs, UPCs, GTINs, and/or other unique product or service identifiers. The information displayed on the display 301 for each of the consumer goods may be calculated and/or provided to the electronic device of the seller S₁ by the demand analytics processor 121 of the electronic exchange 100. For example, the display 301 may display information regarding offers for a TV, a golf club, and running shoes, each of which consumer goods is determined by the demand analytics processor 121 to be in the inventory I₁ of the seller S₁. Moreover, if the seller S₁ receives multiple offers for the same consumer good, such as the TV, then a user of the electronic device of the seller S₁ may use a user interface of the electronic device to sort/group the offers by consumer good. FIG. 4H also illustrates that the user may receive many of the options/features that are illustrated in FIG. 4G. For example, FIG. 4H illustrates the “Demand Analytics Preferences” button 405, and it will be understood that the “Demand Analytics Preferences” button 405 may allow a user of the electronic device of the seller S₁ to access a menu that allows the user to adjust demand analytics preferences with respect to individual consumer goods and/or groups of consumer goods. As an example, the user could set a global demand analytics preference dictating that all offers for all consumer goods must provide a profit margin of at least 10%, and/or an individual demand analytics preference dictating that offers for the TV must provide a profit margin of at least 15%.

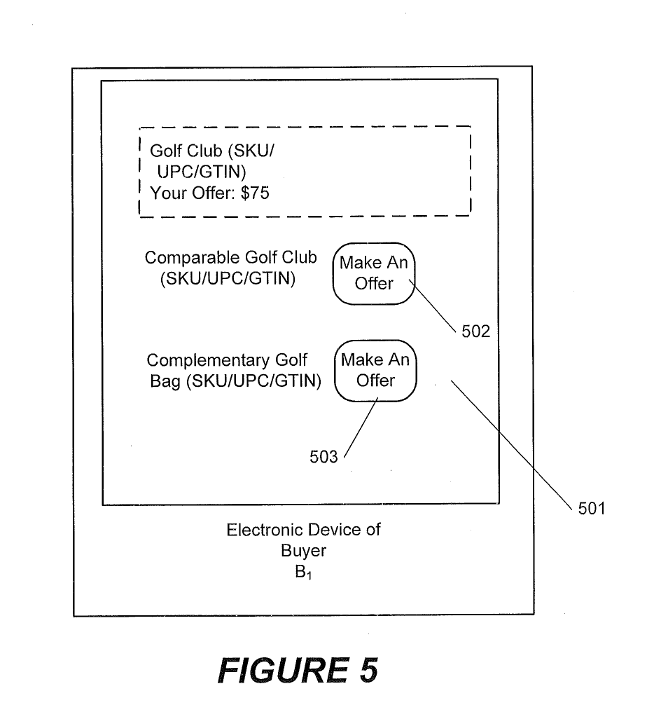

Referring now to FIG. 5, a block diagram is provided that illustrates a display 501 of an electronic device of a buyer B₁ of FIG. 1A after the buyer B₁ has submitted an offer to purchase a consumer good, according to various embodiments. For example, if the buyer B₁ submits an offer to purchase a golf club corresponding to a particular SKU, UPC, GTIN, and/or other unique product identifier at $75.00, then the demand analytics processor 121 may provide the buyer B₁ with a suggestion to submit an offer for a comparable golf club, and/or a golf bag that would complement the golf club for which the buyer B₁ has submitted the $75.00 offer. As an example, the display 501 of the buyer B₁ may indicate “Make An Offer” buttons 502 and 503 corresponding to the comparable golf club and complementary golf bag, respectively.

Accordingly, the electronic exchange 100 described herein may include a demand analytics processor 121 that is configured to optimize transactions for buyers B₁-Bₙ and/or sellers S₁-Sₙ. For example, the demand analytics processor 121 may be configured to use one or more filters 123 associated with the electronic order book 113 to optimize a plurality of offers, from the buyers B₁-Bₙ, that match a seller inventory I of a particular seller S. This optimization may be based on one or more demand analytics preferences of the seller S for a consumer good. The optimization may include determining, using the demand analytics preference(s), whether to make the plurality of offers available to the seller S and/or how to communicate (e.g., display) the plurality of offers to the seller S. Moreover, the demand analytics processor 121 may generate suggestions, for the buyers of consumer goods that are comparable/complementary to consumer goods for which the buyers B₁-Bₙ have submitted offers. The demand analytics processor 121 may thus allow sellers S₁-Sₙ to access real-time demand analytics information that may help to improve determinations of buyer demand, and may thus help to improve pricing precision and profit/profit margins.

In the specification, various embodiments of the inventive concepts have been disclosed and, although specific terms are employed, they are used in a generic and descriptive sense only and not for purposes of limitation. Those skilled in the art will readily appreciate that many modifications are possible for the disclosed embodiments without materially departing from the teachings and advantages of the inventive concepts. The inventive concepts are defined by the following claims, with equivalents of the claims to be included therein.

What is claimed is:

1. A method of facilitating a buyer-driven transaction, comprising:
receiving at an electronic exchange a plurality of offers from a plurality of respective buyers to purchase a product or service at a plurality of respective buyer-determined prices;
searching seller inventory data or seller capacity data from at least one database to match the plurality of offers with at least one seller inventory or seller schedule that includes the product or service; and
using one or more filters to optimize the plurality of offers that match a seller inventory or seller schedule among the at least one seller inventory or seller schedule for a particular seller, based on a demand analytics preference of the particular seller for the product or service, by determining whether to make the plurality of offers available to the particular seller and/or how to communicate the plurality of offers to the particular seller.

2. The method of claim 1, wherein optimizing the plurality of offers comprises sorting the plurality of offers based on at least one of profit margin for the particular seller with respect to the product or service at the plurality of buyer-determined prices and a comparison of raw prices of the plurality offers for the product or service.

3. The method of claim 1, further comprising receiving at the electronic exchange an acceptance of at least one of the plurality of offers from an individual seller whose inventory or schedule is included among the at least one seller inventory or schedule.

4. The method of claim 3, wherein the individual seller comprises the particular seller for whom the plurality of offers are optimized.

5. The method of claim 1, further comprising providing a suggestion to one of the plurality of buyers of a comparable product or service with respect to the product or service and/or a complementary product or service with respect to the product or service.

6. The method of claim 5, wherein providing the suggestion comprises providing the suggestion in response to at least one of acceptance of an offer from the one of the plurality of buyers by an individual seller whose inventory or schedule is included among the at least one seller inventory or schedule and rejection of the offer by the individual seller.

7. The method of claim 1, wherein the plurality of offers from the plurality of respective buyers comprise a plurality of unconditional offers from the plurality of respective buyers.

8. An electronic exchange for facilitating a buyer-driven transaction, comprising:
an electronic order book configured to receive an offer from a buyer to purchase a product or service at a buyer-determined price, and to receive an acceptance of the offer from an individual seller;
an inventory processor configured to search seller inventory data or seller capacity data to match the offer with at least one seller inventory or seller schedule that includes the product or service, wherein an inventory or schedule of the individual seller is included among the at least one seller inventory or seller schedule; and
a demand analytics processor configured to determine whether to make the offer available to a particular seller after the inventory processor matches the offer with the particular seller, based on a demand analytics preference for the product or service, wherein the demand analytics processor is further configured to adjust whether the offer is made available to the particular seller and/or how the offer is communicated to the particular seller in response to an adjustment by the particular seller of the demand analytics preference for the product or service.

9. The electronic exchange of claim 8, wherein the demand analytics preference for the product or service comprises a preference with respect to at least one of profit margin for the particular seller with respect to the product or service at the buyer-determined price and a comparison of the offer with at least one other offer for the product or service.

10. The electronic exchange of claim 8, wherein the adjustment is entered via a user interface of an electronic device of the particular seller.

11. The electronic exchange of claim 8, wherein the demand analytics processor is further configured to determine a suggestion for the buyer of a comparable product or service with respect to the product or service and/or a complementary product or service with respect to the product or service.

12. The electronic exchange of claim 11, wherein the demand analytics processor is further configured to provide the suggestion to the buyer in response to at least one of acceptance of the offer by the individual seller, rejection of the offer by the particular seller, and failure of the buyer to make the offer within a threshold time period.

13. The electronic exchange of claim 8, wherein the individual seller comprises the particular seller having the demand analytics preference for the product or service.

14. The electronic exchange of claim 8, wherein the offer from the buyer comprises an unconditional offer.

15. A products or services demand analytics system, comprising:
a processor configured to determine whether to make an offer from a buyer to purchase a product or service at a buyer-determined price available to a seller of the product or service, based on a demand analytics preference of the seller for the product or service, wherein the processor is further configured to adjust whether the offer is made available to the seller and/or how the offer is communicated to the seller in response to an adjustment by the seller of the demand analytics preference for the product or service.

16. The products or services demand analytics system of claim 15, wherein the demand analytics preference for the product or service comprises a preference with respect to at least one of profit margin for the seller with respect to the product or service at the buyer-determined price and a comparison of the offer with at least one other offer for the product or service.

17. The products or services demand analytics system of claim 16, wherein the comparison of the offer with at least one other offer for the product or service comprises ranking the offer and the at least one other offer.

18. The products or services demand analytics system of claim 15, wherein the processor is further configured to determine a suggestion for the buyer of a comparable product or service with respect to the product or service and/or a complementary product or service with respect to the product or service.

19. The products or services demand analytics system of claim 15, wherein the processor is further configured to determine real-time demand information for the product or service and to provide the real-time demand information to the seller.

20. The products or services demand analytics system of claim 19, wherein the real-time demand information comprises a plurality of offers from a plurality of buyers for the product or service during a given time period and total profit and/or a total profit margin that would be realized by the seller upon acceptance of the plurality of offers.

21. The products or services demand analytics system of claim 20, wherein the processor is further configured to provide the seller with an option to accept all of the plurality of offers with a single selection of an acceptance button.

22. The products or services demand analytics system of claim 15, wherein the offer from the buyer comprises an unconditional offer.
